(19) United States
(12) Patent Application Publication
(10) Pub. No.: US 2016/0035287 A1
(43) Pub. Date: Feb. 4, 2016

(54) SYSTEMS AND METHODS FOR COMPENSATING PARASITIC COUPLINGS IN DISPLAY PANELS

(71) Applicant: Texas Instruments Incorporated, Dallas, TX (US)

(72) Inventors: Timothy Bryan Merkin, Richardson, TX (US); Harish Venkataraman, Wylie, TX (US); Susan Curtis, Sherman, TX (US)

(21) Appl. No.: 14/812,463

(22) Filed: Jul. 29, 2015

Related U.S. Application Data
(60) Provisional application No. 62/032,210, filed on Aug. 1, 2014.

(51) Int. Cl. G09G 3/34; G09G 3/36

(52) U.S. Cl. CPC G09G 3/3406; G09G 3/3685; G09G 2310/08; G09G 2300/0426

(57) ABSTRACT

A display panel includes multiple pixel elements for composing an image and a control circuit for accessing each pixel element. The control circuit includes a data line for conducting a luminance signal and a selection line for conducting a selection signal. Each pixel element includes a switch, a display cell, and a compensatory capacitor. The switch is connected to the data line and the selection line, such that the switch can selectively deliver the luminance signal to the display cell. The display cell is configured to adjust its light transmittance in response to the received luminance signal. Being connected to the switch and the display cell, the compensatory capacitor is configured to receive a compensation signal corresponding to a transition of the selection signal and for correcting a parasitic effect at the display cell.

### CROSS REFERENCE TO RELATED APPLICATIONS

Under 35 U.S.C. §119(e), this application claims the benefit of priority of U.S. Provisional Application 62/032,210 (Texas Instruments docket number TI-71317PS) filed Aug. 1, 2014, which is hereby incorporated by reference in its entirety.

### BACKGROUND

Liquid crystals (LC) have been used as light modulating materials in display panels of various electronic devices. In general, a liquid crystal display (LCD) panel includes numerous LC cells, each of which is responsible for adjusting the brightness of a colored pixel. An LC cell typically has a sandwich structure, which includes a layer of LC molecules (e.g., LC fluid) positioned between two substrate layers. These substrate layers are made of transparent materials (e.g., glass) so as to allow the passage of light rays. These substrate layers also include conducting electrodes on their respective inner surfaces facing the LC layer. The LC molecules may have a range of orientations (e.g., tilt angles) adjustable by a voltage applied across the conducting electrodes of the substrate layers. The light transmittance of an LC cell is often a function of the LC molecules' orientation. Thus, the brightness (or luminance) of an LC cell can be adjusted by controlling the voltage across an LC cell.

An LCD panel typically includes a selection circuit for accessing and delivering the control voltage across each LC cell. To minimize the thickness of the LCD panel, the selection circuit is built with thin-film transistor (TFT) technology. These thin-film transistors demonstrate parasitic effects during the operations of the LC cells. These parasitic effects may impact the performance and reliability of an LCD panel. Attempts have been made in the past to compensate these parasitic effects by modifying the LC cell selection mechanism. However, these compensation schemes involve complicated gate driver electronics, which lead to an increase in panel size as well as power consumption. Thus, there is a need for a display panel that compensates parasitic effects with simplified gate logics.

### SUMMARY

The present disclosure describes systems and techniques relating to the structure and operation of display panels, such as liquid crystal display (LCD) panels with thin-film transistor (TFT) logic control. The disclosed display panels implement one or more compensation schemes to enhance the performance and reliability thereof but without substantially increasing the panel size or power consumption.

In one implementation, for example, a display panel includes a data line, a selection line, an LCD cell, a switch, and a restoration circuit. The data line is configured to conduct a luminance signal. The selection line is configured to conduct a selection signal having an active period and an inactive period. The switch is coupled to the selection line and the data line. Serving as a part of an access means to the LCD cell, the switch is configured to deliver the luminance signal to the second terminal of the LCD cell during only the active period of the selection signal. The LCD cell has a first terminal that is configured to receive a common voltage and a second terminal that is configured to receive the luminance signal. The restoration circuit is coupled to the second terminal of the LCD cell. Serving as a compensating means, the restoration circuit is configured to compensate a distortion of the luminance signal at the second terminal when the selection signal transits from the active period to the inactive period.

In another implementation, for example, a display panel includes a data line, a selection line, a LCD cell, a switch, and a capacitor. The data line is configured to conduct a luminance signal. The selection line is configured to conduct a selection signal having an active period and an inactive period. The switch is coupled to the selection line and the data line. Serving as a part of an access means to the LCD cell, the switch is configured to deliver the luminance signal to the second terminal of the LCD cell during only the active period of the selection signal. The LCD cell has a first terminal that is configured to receive a common voltage and a second terminal that is configured to receive the luminance signal. The capacitor has a first terminal and a second terminal. The first terminal is coupled to the LCD cell. The second terminal is configured to receive a compensation signal corresponding to a transition of the selection signal. Serving as a compensating means, the capacitor is configured to compensate a distortion of the luminance signal at the second terminal of the LCD cell.

In yet another implementation, for example, a display panel includes a data line, a selection line, a LCD cell, a first thin-film transistor (TFT), and a second TFT. The data line is configured to conduct a luminance signal. The selection line is configured to conduct a selection signal having an active period and an inactive period. The LCD cell has a first terminal that is configured to receive a common voltage and a second terminal that is configured to receive the luminance signal.

The first TFT includes a first drain terminal, a first source terminal, and a first gate terminal. The first drain terminal is coupled to the data line, whereas the source terminal is coupled to the second terminal of the LCD cell. The first gate terminal is coupled to the selection line, so that it can control the passage of the luminance signal to the LCD cell. In particular, the first gate terminal is configured to pass the luminance signal from the drain terminal to the source terminal during the active period of the selection signal, and it is configured to block the luminance signal from reaching the source node during the inactive period of the selection signal.

The second TFT includes a second drain terminal, a second source terminal, and a second gate terminal. The second drain terminal is coupled to the second terminal of the LCD cell, whereas the second source terminal is coupled to the drain terminal. The second gate terminal is configured to receive a compensation signal for inducing a charge at the second terminal of the LCD cell during the inactive period of the selection signal. Serving as a compensating means, the second TFT is configured to compensate a distortion of the luminance signal at the second terminal of the LCD cell.

The described systems and techniques can be implemented in electronic circuitry, computer hardware, firmware, software, or in combinations of them, such as the structural means disclosed in this specification and structural equivalents thereof. This can include at least one computer-readable medium embodying a program operable to cause one or more data processing apparatus (e.g., a signal processing device including a programmable processor) to perform operations described. Thus, program implementations can be realized from a disclosed method, system, or apparatus; and apparatus implementations can be realized from a disclosed system, computer-readable medium, or method. Similarly, method implementations can be realized from a disclosed system, computer-readable medium, or apparatus; and system implementations can be realized from a disclosed method, computer-readable medium, or apparatus.

For example, one or more disclosed embodiments can be implemented in various systems and apparatus, including, but not limited to, a special purpose data processing apparatus (e.g., a wireless communication device such as a wireless access point, a remote environment monitor, a router, a switch, a computer system component, a medium access unit), a mobile data processing apparatus (e.g., a wireless client, a cellular telephone, a smart phone, a personal digital assistant (PDA), a mobile computer, a digital camera), a general purpose data processing apparatus such as a computer, or combinations of these.

### DRAWING DESCRIPTIONS

FIG. 1 shows a schematic view of an exemplary display panel according to an aspect of the present disclosure.

FIG. 2 shows a transient diagram of various signals related to an exemplary display panel according to an aspect of the present disclosure.

FIG. 3A shows a schematic view of an exemplary display panel according to an aspect of the present disclosure.

FIG. 3B shows a schematic view of an exemplary display panel according to another aspect of the present disclosure.

FIG. 3C shows a schematic view of an exemplary display panel according to yet another aspect of the present disclosure.

Like reference symbols in the various drawings indicate like elements. Details of one or more implementations of the present disclosure are set forth in the accompanying drawings and the description below. The figures are not drawn to scale and they are provided merely to illustrate the disclosure. Specific details, relationships, and methods are set forth to provide an understanding of the disclosure. Other features and advantages may be apparent from the description and drawings, and from the claims.

### DETAILED DESCRIPTION

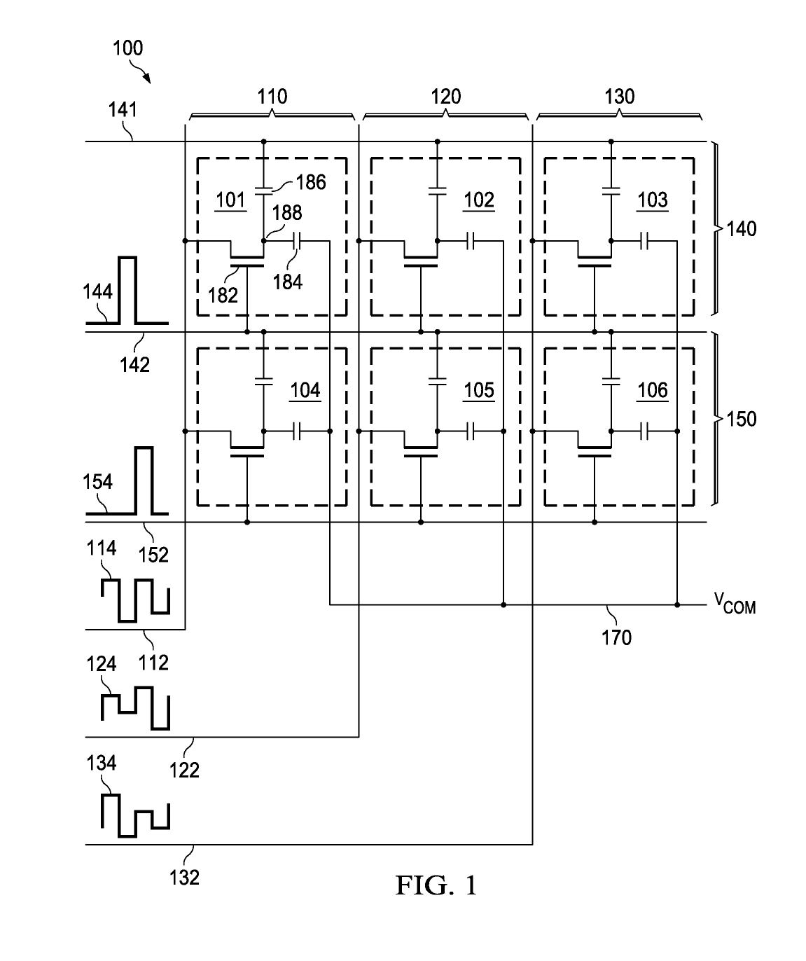

FIG. 1 shows a schematic view of an exemplary display panel 100 according to an aspect of the present disclosure. The display panel 100 includes an array of pixel elements arranged in a row-and-column configuration. For the sake of simplicity, FIG. 1 only shows a 2-by-3 array of pixel elements though the display panel 100 may include a much larger array of pixel elements. The first row 140 of pixel elements can be accessed using a first selection line 142. Specifically, the first selection line 142 is configured to conduct or carry a first selection signal 144. During its active period, the first selection signal 144 can be used for accessing a first pixel element 101, a second pixel element 102, and a third pixel element 103. The second row 150 of pixel elements can be accessed using a second selection line 152. Specifically, the second selection line 152 is configured to conduct or carry a second selection signal 154. During its active period, the second selection signal 154 can be used for accessing a fourth pixel element 104, a fifth pixel element 105, and a sixth pixel element 106.

While being accessed, each pixel element may receive a luminance signal from a data line that is dedicated to a column of pixel elements. For example, the display panel 100 has three columns of pixel elements, and each column is served by one data line. The first data line 112 is dedicated to the first column 110 of pixel elements. The first data line 112 is configured to conduct a first luminance signal 114, which carries information regarding the light transmittance of a selected pixel element in the first column 110 (i.e., the first pixel element 101 or the fourth pixel element 104). The first column 110 of pixel elements may be assigned with a certain chrominance, such as a red color. In that case, the first luminance signal 114 is used for adjusting the brightness of the red color to be projected by the selected pixel element.

The second data line 122 is dedicated to the second column 120 of pixel elements. The second data line 122 is configured to conduct a second luminance signal 124, which carries information regarding the light transmittance of a selected pixel element in the second column 120 (i.e., the second pixel element 102 or the fifth pixel element 105). The second column 120 of pixel elements may be assigned with a certain chrominance, such as a blue color, different from that of the first column 110. In that case, the second luminance signal 124 is used for adjusting the brightness of the blue color to be projected by the selected pixel element.

The third data line 132 is dedicated to the third column 130 of pixel elements. The third data line 132 is configured to conduct a third luminance signal 134, which carries information regarding the light transmittance of a selected pixel element in the third column 130 (i.e., the third pixel element 103 or the sixth pixel element 106). The third column 130 of pixel elements may be assigned with a certain chrominance, such as a green color, different from those of the first column 110 and the second column 120. In that case, the third luminance signal 134 is used for adjusting the brightness of the green color to be projected by the selected pixel element.

Each pixel element includes a switch, a display cell, a storage capacitor, and a pixel electrode. For example, the first pixel element 101 includes a switch 182, a display cell 184, a storage capacitor 186, and a pixel electrode 188. The switch 182 is used for accessing the first pixel element 101. Specifically, the switch 182 is coupled with the first selection line 142 to receive the first selection signal 144. During an active period of the first selection signal 144, the switch 182 is activated to pass the first luminance signal 114 from the first data line 112 to the pixel electrode 188. During an inactive period of the first selection signal 144, the switch 182 is deactivated to block the first luminance signal 114 from reaching the pixel electrode 188.

Upon receiving the first luminance signal 114 at the pixel electrode 188, the first pixel element 101 stores the corresponding luminance data as charges in the storage capacitor 186. In one implementation, the storage capacitor 186 is coupled between a selection line dedicated to a previous row (e.g., a dummy selection line 141) and the pixel electrode 188. The first luminance signal 114 also helps establish a pixel voltage (V_{PIX}) across the display cell 184. This pixel voltage (V_{PIX}) is sustained by the storage capacitor 186 when the pixel electrode 188 is decoupled from the first data line 112 during an inactive period of the first selection signal 144.

The display cell 184 is coupled to the pixel electrode 188 to receive the first luminance signal 114, and it is also coupled to a common line 170 to receive a common signal that carries a common voltage (V_{COM}). The common voltage (V_{COM}) is shared by a group of display cells of a block of pixel elements. Together, the luminance signal (e.g., the first luminance signal 114) and the common signal establish the pixel voltage (V_{PIX}) of a particular display cell. In response, the display cell 184 is configured to adjust its light transmittance based on the pixel voltage (V_{PIX}) established thereacross.

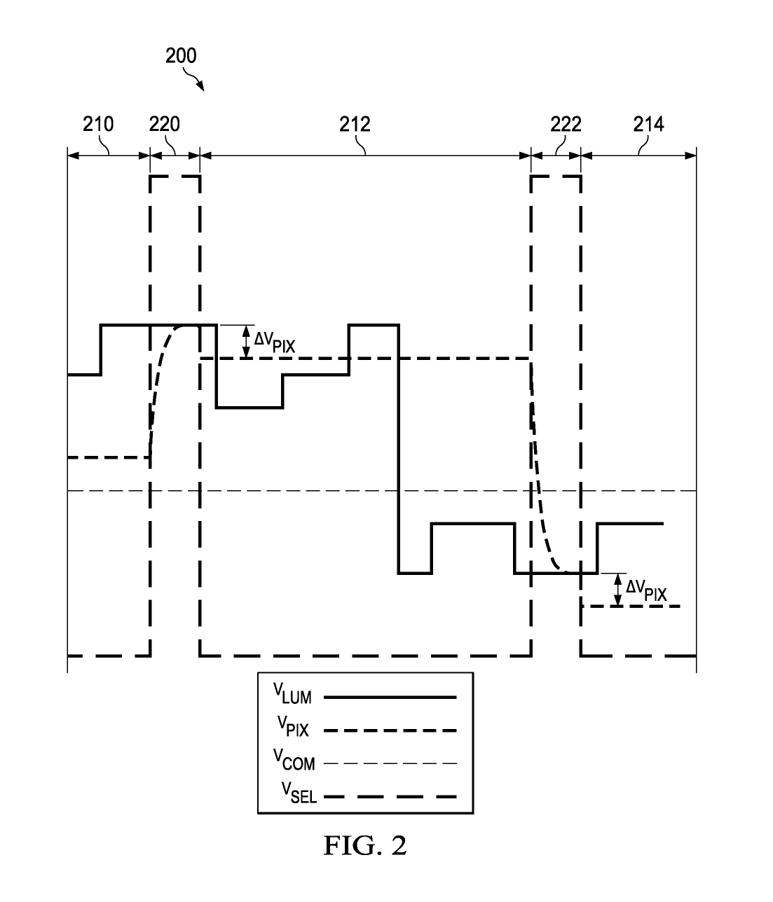

FIG. 2 shows a transient diagram 200 of various signals related to an exemplary display panel, such as the display panel 100, according to an aspect of the present disclosure. During a first inactive period 210 of a selection signal V_{SEL} (e.g., 144), the pixel electrode (e.g., 188) of the associated pixel element (e.g., 101) is decoupled from the associated data line (e.g., 112). As a result, the pixel electrode does not receive the corresponding luminance signal V_{LUM} (e.g., 114) from the associated data line.

When the selection signal V_{SEL} transits from the first inactive period 210 to a first active period 220, the switch (e.g., 182) of the pixel element is activated to pass the luminance signal V_{LUM} from the data line to the pixel electrode. As a result, the potential of the pixel voltage V_{PIX} begins to rise. At the end of the first active period 220, the pixel voltage V_{PIX} may reach the same level as the luminance signal V_{LUM}.

When the selection signal V_{SEL} transits from the first active period 220 to a second inactive period 212, the switch of the pixel element is again deactivated to block the luminance signal V_{LUM} from reaching the pixel electrode. As a result, the pixel electrode becomes a floating node. The pixel voltage V_{PIX} of the pixel electrode is sustained by the storage capacitor during the second inactive period 212. The switch, however, may exhibit parasitic capacitance across its gate terminal and source terminal. As a result, the pixel electrode is parasitically coupled with the corresponding selection line.

During a falling edge of the selection signal V_{SEL}, the pixel voltage V_{PIX} experiences a pixel voltage drop ΔV_{PIX} due to this parasitic coupling between the pixel electrode and the selection line. A significant pixel voltage drop ΔV_{PIX} will directly impact the light transmittance of the display cell, thereby creating a flicker effect across a row of pixel elements. This flicker effect may reoccur during subsequent transitions of the selection signal V_{SEL} (e.g., from a second active period 222 to a third inactive period 214). As a result, the parasitic coupling caused by the switch may degrade the performance and reliability of the display panel.

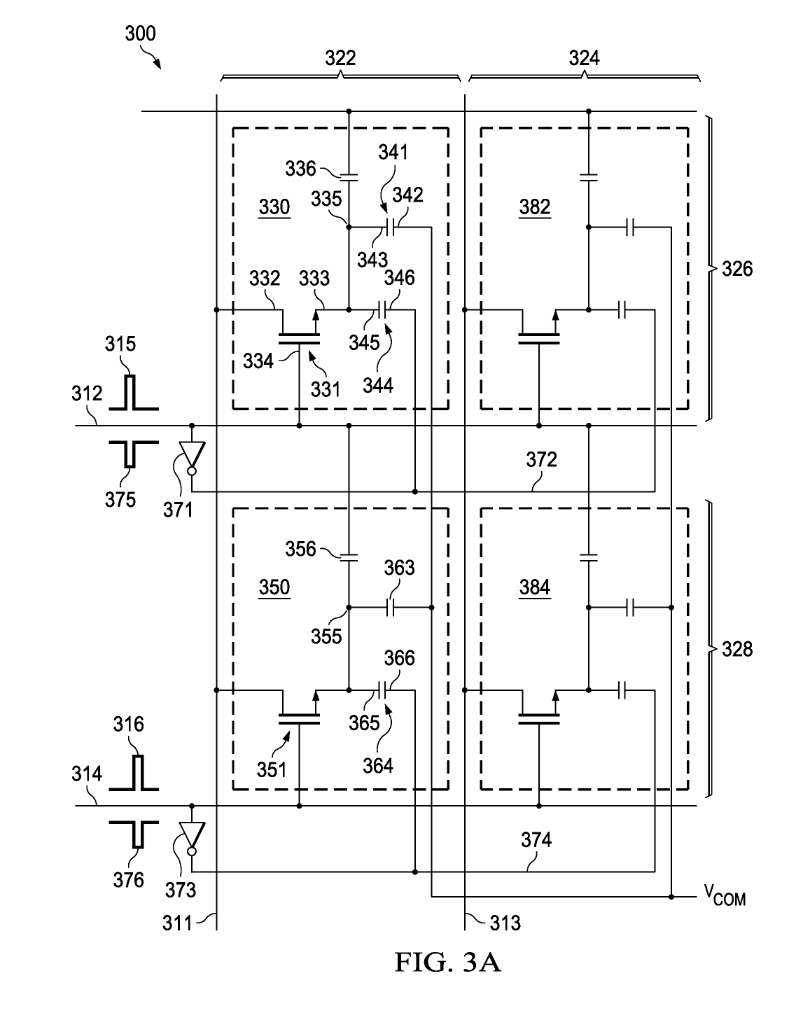

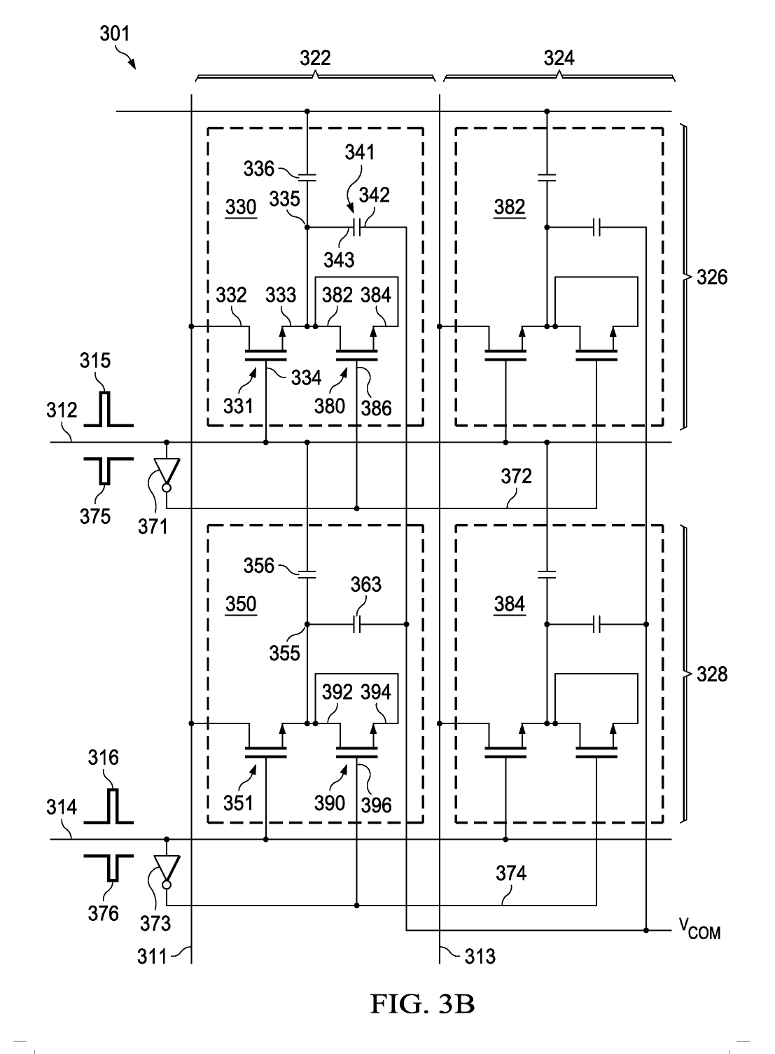

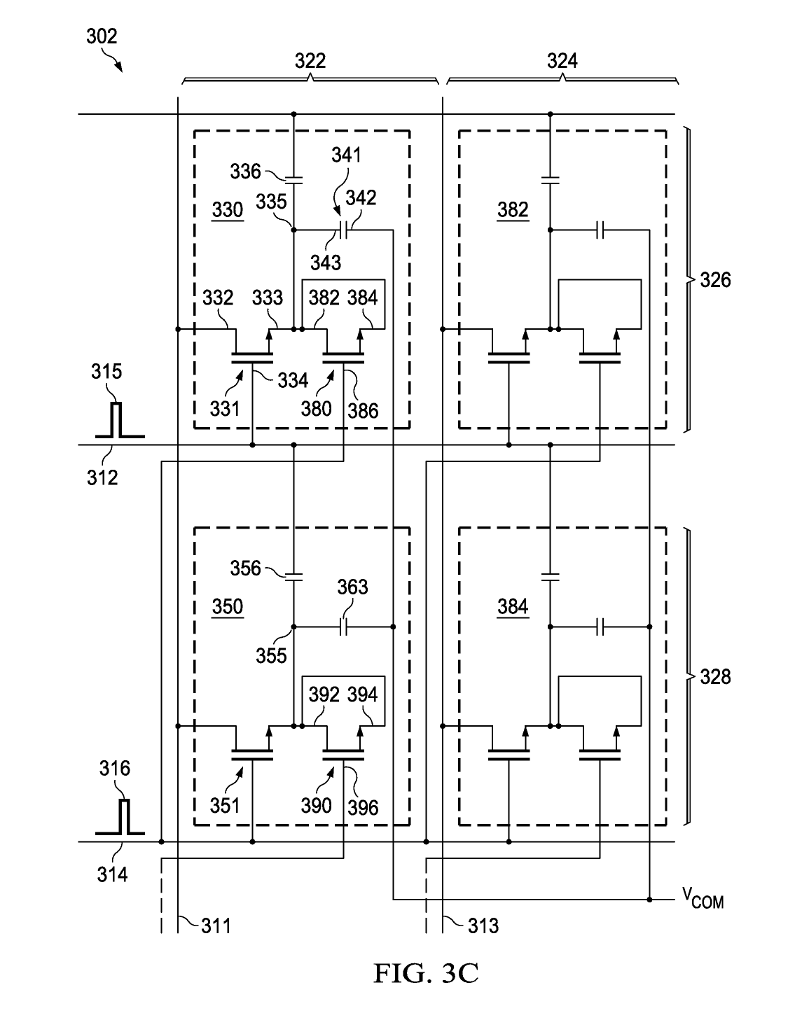

To correct this flicker effect, the present disclosure introduces several display panel configurations that compensate the parasitic coupling caused by the switch. These display panel configurations take advantage of the existing control signals, so as to minimize the need of adding control logics and increasing power consumption. FIG. 3A shows a schematic view of an exemplary display panel 300. The display panel 300 adopts most of the structure features of the display panel 100. In addition, the display panel 300 incorporates a restoration circuit to each row of pixel elements. Each restoration circuit is configured to compensate a distortion of the luminance signal (e.g., ΔV_{PIX}) at the pixel electrode when the selection signal transits from its active period to its inactive period.

Like the display panel 100, the display panel 300 includes an array of pixel elements arranged in a row-and-column configuration. For the sake of simplicity, FIG. 3A only shows a 2-by-2 array of pixel elements though the display panel 300 may include a much larger array of pixel elements. The first row 326 of pixel elements can be accessed using a first selection line 312. Specifically, the first selection line 312 is configured to conduct or carry a first selection signal 315. During its active period, the first selection signal 315 can be used for accessing a first pixel element 330 and a third pixel element 382. The second row 328 of pixel elements can be accessed using a second selection line 314. Specifically, the second selection line 314 is configured to conduct or carry a second selection signal 316. During its active period, the second selection signal 316 can be used for accessing a second pixel element 350, and a fourth pixel element 384.

While being accessed, each pixel element may receive a luminance signal from a data line that is dedicated to a column of pixel elements. For example, the display panel 300 has two columns of pixel elements, and each column is served by one data line. The first data line 311 is dedicated to the first column 322 of pixel elements. The first data line 311 is configured to conduct a first luminance signal, which carries information regarding the light transmittance of a selected pixel element in the first column 322 (i.e., the first pixel element 330 or the second pixel element 350). The first column 322 of pixel elements may be assigned with a certain chrominance. In that case, the first luminance signal is used for adjusting the brightness of the assigned chrominance to be projected by the selected pixel element.

The second data line 313 is dedicated to the second column 324 of pixel elements. The second data line 313 is configured to conduct a second luminance signal, which carries information regarding the light transmittance of a selected pixel element in the second column 324 (i.e., the third pixel element 382 or the fourth pixel element 384). The second column 324 of pixel elements may be assigned with a chrominance different from that of the first column 322. In that case, the second luminance signal is used for adjusting the brightness of the assigned chrominance to be projected by the selected pixel element.

Each pixel element includes a switch, a display cell, a storage capacitor, and a pixel electrode. In an implementation where crystal liquid is adopted as the light transmittance material, the display cell is a liquid crystal display (LCD) cell. To minimize the thickness of the display panel, a thin-film transistor (TFT) can be used for implementing the switch in each pixel element. More specifically, the first pixel element 330 includes a first TFT switch 331, a first LCD cell 341, a first storage capacitor 336, and a first pixel electrode 335.

The first LCD cell 341 has a first terminal 342 that is configured to receive a common voltage (V_{COM}) and a second terminal 343 that is coupled with the first pixel electrode 335 to receive the luminance signal. The first TFT switch 331 is used for accessing the first pixel element 330. Specifically, the first TFT switch 331 is coupled to the first selection line 312 to receive the first selection signal 315. During an active period (see, e.g., active periods 220 and 222 as shown in FIG. 2) of the first selection signal 315, the first TFT switch 331 is activated to pass the first luminance signal from the first data line 311 to the pixel electrode 335. During an inactive period (see, e.g., inactive periods 210 and 212 as shown in FIG. 2) of the first selection signal 315, the first TFT switch 331 is deactivated to block the first luminance signal from reaching the pixel electrode 335.

To serves as a mean for selectively delivering the luminance signal, the first TFT switch 331 includes a drain terminal 332, a source terminal 333, and a gate terminal 334. The drain terminal 332 is connected to the first data line 311 for receiving the first luminance signal. The source terminal 333 is coupled to second terminal 343 of the first LCD cell 341 via the first pixel electrode 335. The gate terminal 334 is connected to the first selection line 312. Accordingly, the gate terminal 334 controls the passage of the luminance signal from the drain terminal 332 to the source terminal 333 during the active period of the first selection signal 315, and the gate terminal 334 also controls the blockage of the luminance signal from reaching the source node 333 during the inactive period of the first selection signal 315.

To correct the flicker effects introduced by the parasitic coupling of the TFT switch, the display panel 300 includes a restoration circuit for each row of pixel elements. For example, a first restoration circuit is used for compensating the falling edge coupling effect of the first selection signal 315. The first restoration circuit can be coupled to the second terminal 343 of the first LCD cell 341 via the first pixel electrode 335. Specifically, the first restoration circuit is configured to compensate a distortion of the luminance signal at the second terminal 343 when the first selection signal 315 transits from an active period to an inactive period.

In general, the restoration circuit includes a complementary circuit and a compensation circuit. The complementary circuit is coupled to a selection line to generate a compensation signal. The compensation signal is typically used for compensating or partially cancelling the flicker effect introduced by the corresponding selection signal. In one implementation, for example, a complementary circuit of the first restoration circuit may include a first inverter 371. The first inverter 371 has an input terminal that is connected to the first selection line 312, and an output terminal that is connected to a first complementary line 372. Accordingly, the output terminal of the first inverter 371 is configured to deliver a first compensation signal 375 to the first complementary line 372. Due to the operation of the first inverter 371, the first compensation signal 375 is generated based on one or more transitions (e.g., falling edges and rising edges) of the first selection signal 315.

The compensation circuit of the restoration circuit is coupled with the corresponding complementary line to receive the compensation signal. In return, the compensation circuit is coupled with the corresponding pixel electrode to induce a charge thereto during the inactive period of the selection signal. In one implementation, for example, a compensation circuit of the first restoration circuit may include a first compensatory capacitor 344 as well as additional compensatory capacitors that are coupled to the pixel electrodes of the pixel elements (e.g., the pixel element 382) in the first row 326. The first compensatory capacitor 344 is coupled between the complementary circuit (e.g., the first inverter 371) and the second terminal 343 of the first LCD cell 341. The first compensatory capacitor 344 includes a first terminal 345 and a second terminal 346. The first terminal 345 is connected to the first LCD cell 341 via the first pixel electrode 335. The second terminal 346 is connected to the first complementary line 372 for receiving the first compensation signal 375.

Upon receiving the first compensation signal 375, the first compensatory capacitor 344 is configured to induce a coupling charge at the second terminal 343 of the first LCD cell 341 during the inactive period of the first selection signal 315. As a result, the first compensatory capacitor 344 serves as a means for restoring the charges depleted from the first storage capacitor 336 due to the parasitic coupling of the first TFT switch 331. As a whole, the first restoration circuit serves as a means for compensating the pixel voltage distortion (i.e., ΔV_{PIX}) of the first luminance signal, thereby correcting the flicker effect of the first pixel element 330.

The display panel 300 may include additional restoration circuits for subsequent rows of pixel elements. In one implementation, for example, a second restoration circuit is used for compensating the parasitic coupling caused by the falling edge of the second selection signal 316. The second restoration circuit can be coupled to the second LCD cell 363 via the second pixel electrode 355 of the second pixel element 350. Specifically, the second restoration circuit is configured to compensate a distortion of the luminance signal for the second LCD cell 363 when the second selection signal 316 transits from an active period to an inactive period.

The second restoration circuit shares a similar circuit structure as the first restoration circuit. As such, the second restoration circuit includes a complementary circuit and a compensation circuit. The complementary circuit is coupled to a selection line to generate a compensation signal. The compensation signal is typically used for compensating or partially cancelling the flicker effect introduced by the corresponding selection signal. In one implementation, for example, a complementary circuit of the second restoration circuit may include a second inverter 373. The second inverter 373 has an input terminal that is connected to the second selection line 314, and an output terminal that is connected to a second complementary line 374. Accordingly, the output terminal of the second inverter 372 is configured to deliver a second compensation signal 376 to the second complementary line 374. Due to the operation of the second inverter 373, the second compensation signal 376 is generated based on one or more transitions (e.g., falling edgings and rising edges) of the second selection signal 316.

A compensation circuit of the second restoration circuit may include a second compensatory capacitor 364 as well as additional compensatory capacitors that are coupled to the pixel electrodes of the pixel elements (e.g., the pixel element 384) in the second row 328. The second compensatory capacitor 364 is coupled between the complementary circuit (e.g., the second inverter 372) and the second LCD cell 363. The second compensatory capacitor 364 includes a first terminal 365 and a second terminal 366. The first terminal 345 is connected to the second LCD cell 363 via the second pixel electrode 355. The second terminal 366 is connected to the second complementary line 374 for receiving the second compensation signal 376.

Upon receiving the second compensation signal 376, the second compensatory capacitor 364 is configured to induce a coupling charge at the second LCD cell 363 during an inactive period of the second selection signal 316. As a result, the second compensatory capacitor 364 serves as a means for restoring the charges depleted from the second storage capacitor 356 due to the parasitic coupling of the second TFT switch 351. As a whole, the second restoration circuit serves as a means for compensating the pixel voltage distortion (i.e., ΔV_{PIX}) of the second luminance signal, thereby correcting the flicker effect of the second pixel element 350.

According to an aspect of the present disclosure, the compensation signal is a complementary version of the selection signal. This complementary version is generally in-phase with the original selection signal. Alternatively, this complementary version can be slightly out-of-phase from the original selection signal so long as the compensation effect induced by the complementary signal is sufficient to overcome the pixel voltage distortion (i.e., ΔV_{PIX}).

When the switch (e.g., the first TFT switch 331) is an N-channel device, the selection signal (e.g., the first selection signal 315) typically has a falling edge transiting from the active period to the inactive period (see, e.g., a transition from the first active period 220 to a second inactive period 212 as shown in FIG. 2). An in-phase compensation signal has a rising edge that is partially overlapping with the falling edge of the selection signal, whereas an out-of-phase compensation signal has a rising edge that either leads or follows the falling edge of the selection signal. In contrast, when the switch (e.g., the first TFT switch 331) is a P-channel device, the selection signal typically has a rising edge transiting from the active period to the inactive period. An in-phase compensation signal has a falling edge that is partially overlapping with the rising edge of the selection signal, whereas an out-of-phase compensation signal has a falling edge that either leads or follows the rising edge of the selection signal.

Since the parasitic coupling of the switch (e.g., the first TFT switch 331) is attributed to a gate-source capacitance established between the gate terminal (e.g., the gate terminal 334) and the source terminal (e.g., the source terminal 333), the compensatory capacitor (e.g., the first compensatory capacitor 344) can be sized to establish a compensatory capacitance that substantially matches with the gate-source capacitance of the switch. In one implementation, for example, the compensatory capacitance of the compensatory capacitor may have a 20% variance range from the gate-source capacitance of the switch. In another implementation, for example, the compensatory capacitance of the compensatory capacitor may have a 10% variance range from the gate-source capacitance of the switch. In one implementation, for example, the compensatory capacitance of the compensatory capacitor may have a 5% variance range from the gate-source capacitance of the switch.

To simplify the fabrication process of the display panel, the compensatory capacitor can be formed using a thin-film transistor (TFT) as well. As shown in FIG. 3B, for example, the display panel 301 implement the compensatory capacitors using one or more TFT-based capacitors. The first pixel element 330 adopts a first TFT compensatory capacitor 380 to replace the first compensatory capacitor 344. The first TFT compensatory capacitor 380 includes a drain terminal 382, a source terminal 384, and a gate terminal 386. The drain terminal 382 is coupled to the second terminal 343 of the first LCD cell 341 via the first pixel electrode 335. The source terminal 384 is tied to the drain terminal 382 to receive the first pixel voltage (V_{PIX1}) from the first pixel electrode 335. The gate terminal 386 is configured to receive the first compensation signal 375 via the first complementary line 372 or other conducting wires. Upon receiving the first compensation signal 375, the gate terminal 386 induces a charge at the second terminal 343 of the first LCD cell 341 during an inactive period of the first selection signal 315.

In similar fashion, the second pixel element 330 adopts a second TFT compensatory capacitor 390 to replace the second compensatory capacitor 364. The second TFT compensatory capacitor 390 includes a drain terminal 392, a source terminal 394, and a gate terminal 396. The drain terminal 392 is coupled to the second LCD cell 363 via the second pixel electrode 355. The source terminal 394 is tied to the drain terminal 392 to receive the second pixel voltage (V_{PIX2}) from the second pixel electrode 355. The gate terminal 396 is configured to receive the second compensation signal 376 via the second complementary line 374 or other conducting wires. Upon receiving the second compensation signal 376, the gate terminal 396 induces a charge at the second LCD cell 363 during an inactive period of the second selection signal 316.

Since the parasitic coupling of the switch (e.g., the first TFT switch 331) is attributed to a gate-source capacitance established between the gate terminal (e.g., the gate terminal 334) and the source terminal (e.g., the source terminal 333), the TFT compensatory capacitor (e.g., the first TFT compensatory capacitor 380) can be sized to establish a compensatory capacitance that substantially matches with the gate-source capacitance of the switch. Assuming that the TFT switch has a first transistor size, the TFT compensatory capacitor may have a second transistor size that is about half of the first transistor size. In one implementation, for example, the second transistor size can have a 20% variance range from half of the first transistor size. In another implementation, for example, the second transistor size can have a 10% variance range from half of the first transistor size. In yet another implementation, for example, the second transistor size can have a 5% variance range from half of the first transistor size.

To further reduce the complexity of the restoration circuit, the present disclosure provides a parasitic compensation scheme that takes advantage of the existing control signals and gate logics. As shown in FIG. 3C, a display panel 302 adopts a compensation scheme in which a selection signal for an adjacent row of pixel elements can be used as the compensation signal of a previous row of pixel elements. More specifically, the compensatory capacitor is coupled with the next selection line to receive a compensation signal. This particular configuration eliminates the need of the complementary circuit, and thus further simplifies the implementation of the parasitic compensation scheme. For instance, instead of connecting to the first complementary line 372 as shown in FIGS. 3A-3B, the first compensatory capacitor 380 (or 344) connects to the second selection line 314.

By way of operation, the active period of the second selection signal 316 typically follows the active period of the first selection signal 315. Thus, the rising edge of the second selection signal 316 may partially overlap with, or immediately follow, the falling edge of the first selection signal 315. And in a configuration which P-channel TFTs are used for implementing the switches, the falling edge of the second selection signal 316 may partially overlap with, or immediately follow, the rising edge of the first selection signal 315. As such, the first compensatory capacitor 380 can take advantage of the active period of the second selection signal 316 to induce a compensatory charge at the first pixel electrode 335 during an inactive period of the first selection signal 315.

The display panels as shown in FIGS. 3A-3C removes a DC shift induced by the falling edges of a selection signal without adding complicated common signal (V_{COM}) calibration scheme. Nor do these display panels depend on individual pixel voltages, panel temperatures, or panel fabrication processes. Accordingly, the present disclosure provides one or more compensation schemes to enhance the performance and reliability of display panels without substantially increasing the panel size or power consumption thereof.

A few embodiments have been described in detail above, and various modifications are possible. The disclosed subject matter, including the functional operations described in this specification, can be implemented in electronic circuitry, computer hardware, firmware, software, or in combinations of them, such as the structural means disclosed in this specification and structural equivalents thereof, including potentially a program operable to cause one or more data processing apparatus to perform the methods and/or operations described (such as a program encoded in a computer-readable medium, which can be a memory device, a storage device, a machine-readable storage substrate, or other physical, machine-readable medium, or a combination of one or more of them).

Consistent with the present disclosure, the term “configured to” purports to describe the structural and functional characteristics of one or more tangible non-transitory components. For example, the term “configured to” can be understood as having a particular configuration that is designed or dedicated for performing a certain function. Within this understanding, a device is “configured to” perform a certain function if such a device includes tangible non-transitory components that can be enabled, activated, or powered to perform that certain function. While the term “configured to” may encompass the notion of being configurable, this term should not be limited to such a narrow definition. Thus, when used for describing a device, the term “configured to” does not require the described device to be configurable at any given point of time.

A program (also known as a computer program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A program can be deployed to be executed on one computer or on multiple computers that are located at one site or distributed across multiple sites and interconnected by a communication network.

While this specification contains many specifics, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results unless such order is recited in one or more claims. In certain circumstances, multitasking and parallel processing may be advantageous. Moreover, the separation of various system components in the embodiments described above should not be understood as requiring such separation in all embodiments.

What is claimed is:

1. A display panel, comprising:
a data line configured to conduct a luminance signal;
a liquid crystal display (LCD) cell configured to adjust a light transmittance based on the luminance signal;
a selection line configured to conduct a selection signal;
a switch coupled to the selection line and the data line, the switch configured to selectively deliver the luminance signal to the LCD cell based on the selection signal; and
a capacitor having a first terminal and a second terminal, the first terminal coupled to the LCD cell, the second terminal configured to receive a compensation signal corresponding to a transition of the selection signal.

2. The display panel of claim 1, wherein the LCD cell includes:
a first terminal configured to receive a common voltage; and
a second terminal coupled to the switch and the capacitor, the second terminal configured to receive the luminance signal during an active period of the selection signal, and the second terminal charge induced by the compensation signal via the capacitor during the transition of the selection signal.

3. The display panel of claim 1, wherein the switch includes a thin-film transistor having:
a drain terminal coupled to the data line;
a source terminal coupled to the LCD cell and the capacitor; and
a gate terminal coupled to the selection line, the gate terminal configured to pass the luminance signal from the drain terminal to the source terminal during an active period of the selection signal and block the luminance signal from reaching the source node during an inactive period of the selection signal.

4. The display panel of claim 3, wherein:
the gate terminal and the source terminal of the thin-film transistor switch defines a gate-source capacitance; and
the capacitor is sized to establish a compensatory capacitance substantially matching the gate-source capacitance of the thin-film transistor switch.

5. The display panel of claim 3, wherein:
the thin-film transistor switch has a first transistor size; and
the capacitor includes a second thin-film transistor having a second transistor size about half of the first transistor size.

6. The display panel of claim 1, wherein the capacitor includes a thin-film transistor having:
a drain terminal coupled to LCD cell;
a source terminal coupled to the drain terminal; and
a gate terminal coupled to a selection compensation line to receive the compensation signal.

7. The display panel of claim 1, wherein the transition of the selection signal includes a falling edge of the selection signal.

8. The display panel of claim 1, wherein the compensation signal is complementary of the selection signal.

9. The display panel of claim 1, further comprising:
a compensation line coupled to the capacitor to provide the compensation signal; and
an inverter coupled between the selection line and the compensation line, the inverter configured to generate the compensation signal by inverting the selection signal.

10. The display panel of claim 1, further comprising:
a second LCD cell configured to adjust a second light transmittance in response to the luminance signal;
a second selection line separated from the first selection line, the second selection line configured to conduct a second selection signal having a second active period following a first active period of the selection signal; and
a second switch coupled to the second selection line and the data line, the second switch configured to deliver the luminance signal to the second LCD cell based on the second selection signal;
wherein the second terminal of the capacitor is coupled to the second selection line to receive the second selection signal as the compensation signal.

11. A display panel, comprising:
a data line configured to conduct a luminance signal;
a liquid crystal display (LCD) cell having a first terminal configured to receive a common voltage and a second terminal configured to receive the luminance signal;
a selection line configured to conduct a selection signal having an active period and an inactive period;
a switch coupled to the selection line and the data line, the switch configured to deliver the luminance signal to the second terminal of the LCD cell during only the active period of the selection signal; and
a restoration circuit coupled to the second terminal of the LCD cell, the restoration circuit configured to compensate a distortion of the luminance signal at the second terminal when the selection signal transits from the active period to the inactive period.

12. The display panel of claim 11, wherein the switch includes a thin-film transistor having:
a drain terminal coupled to the data line;
a source terminal coupled to second terminal of the LCD cell; and
a gate terminal coupled to the selection line, the gate terminal configured to pass the luminance signal from the drain terminal to the source terminal during the active period of the selection signal and block the luminance signal from reaching the source node during the inactive period of the selection signal.

13. The display panel of claim 11, wherein the restoration circuit includes:
a complementary circuit coupled to the selection line to generate a compensation signal based on the selection signal; and
a capacitor coupled between the complementary circuit and the second terminal of the LCD cell.

14. The display panel of claim 13, wherein the complementary circuit includes an inverter having:
an input terminal coupled to the selection line; and
an output terminal coupled to the capacitor, the output terminal configured to deliver the compensation signal inverting the selection signal.

15. The display panel of claim 13, wherein:
the selection signal has a falling edge transiting from the active period to the inactive period; and
the compensation signal has a rising edge partially overlapping with the falling edge of the selection signal.

16. The display panel of claim 13, wherein:
the selection signal has a falling edge transiting from the active period to the inactive period; and
the compensation signal has a rising edge following the falling edge of the selection signal.

17. A display panel, comprising:
a data line configured to conduct a luminance signal;
a liquid crystal display (LCD) cell having a first terminal configured to receive a common voltage and a second terminal configured to receive the luminance signal for adjusting a light transmittance;
a selection line configured to conduct a selection signal having an active period and an inactive period;
a first thin-film transistor having:
a first drain terminal coupled to the data line;
a first source terminal coupled to the second terminal of the LCD cell; and
a first gate terminal coupled to the selection line, the gate terminal configured to:
pass the luminance signal from the drain terminal to the source terminal during the active period of the selection signal; and
block the luminance signal from reaching the source node during the inactive period of the selection signal; and
a second thin-film transistor having:
a second drain terminal coupled to the second terminal of the LCD cell;
a second source terminal coupled to the drain terminal; and
a second gate terminal configured to receive a compensation signal for inducing a charge at the second terminal of the LCD cell during the inactive period of the selection signal.

18. The display panel of claim 17, wherein:
the first thin-film transistor has a first transistor size; and
the second thin-film transistor has a second transistor size about half of the first transistor size.

19. The display panel of claim 17, wherein:
the selection signal has a falling edge transiting from the active period to the inactive period; and
the compensation signal has a rising edge partially overlapping with or following the falling edge of the selection signal.

20. The display panel of claim 17, further comprising:
an inverter having:
an input terminal coupled to the selection line; and
an output terminal coupled to the second gate terminal of the second thin-film transistor, the output terminal configured to deliver the compensation signal inverting the selection signal.
